(19) United States
(12) Patent Application Publication
(10) Pub. No.: US 2024/0341365 A1
(43) Pub. Date: Oct. 17, 2024

(54) ELECTRONIC ATOMIZATION DEVICE

(71) Applicant: VERDEWELL INTERNATIONAL HOLDINGS LIMITED, George Town (KY)

(72) Inventors: Jianguang ZHOU, Shenzhen (CN); Shouhao CHEN, Shenzhen (CN)

(21) Appl. No.: 18/610,848

(22) Filed: Mar. 20, 2024

(30) Foreign Application Priority Data
Apr. 17, 2023 (CN) 202320861704.2

(51) Int. Cl. A24F 40/50; A24F 40/10; A24F 40/42; A24F 40/46; A24F 40/48; H01M 10/42; H01M 50/202; H01M 50/247

(52) U.S. Cl. CPC A24F 40/50; A24F 40/10; A24F 40/42; A24F 40/46; A24F 40/48; H01M 10/425; H01M 50/202; H01M 50/247; H01M 2220/30

(57) ABSTRACT

An electronic atomization device includes: a liquid storage cavity for storing a liquid substrate; an atomization assembly arranged in the liquid storage cavity, the atomization assembly atomizing the liquid substrate; and a power supply assembly including a main control board connected to the atomization assembly, a battery cell connected to the main control board, and a charging interface arranged on the main control board.

### CROSS-REFERENCE TO PRIOR APPLICATION

Priority is claimed to Chinese Patent Application No. 202320861704.2, filed on Apr. 17, 2023, the entire disclosure of which is hereby incorporated by reference herein.

### FIELD

The present invention relates to the field of atomization, and in particular, to an electronic atomization device.

### BACKGROUND

In an electronic atomization device in the related art, a main control board of a power supply assembly and an atomization assembly are usually electrically connected through welding, then the charging interface and the main control board are connected through flexible wires, and manual welding is required during assembly. That is, the electronic atomization device requires multiple welding, and welding wires requires a plurality of skilled welders, leading to high labor costs, low efficiency, and a high defect rate of manually welding wires. There are soldering defects such as poor soldering and pseudo soldering, which may cause desoldering during production line circulation, wire management, and transportation, resulting in a low one-time pass rate, and quality of the final product is unstable, easily causing customer complaints and other issues.

### SUMMARY

In an embodiment, the present invention provides an electronic atomization device, comprising: a liquid storage cavity configured to store a liquid substrate; an atomization assembly arranged in the liquid storage cavity, the atomization assembly being configured to atomize the liquid substrate; and a power supply assembly comprising a main control board connected to the atomization assembly, a battery cell connected to the main control board, and a charging interface arranged on the main control board.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic atomization device according to some embodiments of the present invention;

FIG. 2 is a cross-sectional view of the electronic atomization device shown in FIG. 1 along A-A;

FIG. 3 is a cross-sectional view of the electronic atomization device shown in FIG. 1 along B-B;

FIG. 4 is a schematic partial structural diagram of the electronic atomization device shown in FIG. 1;

FIG. 5 is a schematic structural diagram of a holder in the electronic atomization device shown in FIG. 4;

FIG. 6 is a schematic structural diagram of the holder shown in FIG. 5 from another angle of view;

FIG. 7 is a schematic structural diagram of a mounting base in the electronic atomization device shown in FIG. 4; and

FIG. 8 is a cross-sectional view of the mounting base shown in FIG. 7.

### DETAILED DESCRIPTION

In an embodiment, the present invention provides an improved electronic atomization device.

In an embodiment, the present invention provides an electronic atomization device, including a liquid storage cavity for storing a liquid substrate, an atomization assembly arranged in the liquid storage cavity and for atomizing the liquid substrate, and a power supply assembly.

The power supply assembly includes a main control board connected to the atomization assembly, a battery cell connected to the main control board, and a charging interface arranged on the main control board.

In some embodiments, the battery cell includes a first end facing toward the liquid storage cavity and a second end arranged opposite to the first end; and the main control board is arranged between the first end and the liquid storage cavity.

In some embodiments, the atomization assembly includes a conductive connection portion; and a first connection point connected to the conductive connection portion is provided on the main control board.

In some embodiments, a second connection point connected to the battery cell is provided on the main control board. In some embodiments, a holder is further included, and the main control board is arranged on the holder.

In some embodiments, an air inlet channel in air guide connection to the atomization assembly is further included; and the air inlet channel is arranged on one side of the holder facing away from the main control board.

In some embodiments, the atomization assembly includes a vent tube and a heating structure arranged in the vent tube;
the air inlet channel is in communication with the vent tube; and
a liquid inlet hole in liquid guide connection to the liquid storage cavity is provided on the tube wall of the vent tube arranged corresponding to the heating structure.

In some embodiments, the electronic atomization device further includes a shell for accommodating the holder, and the air inlet channel is at least partially formed between the shell and the holder.

In some embodiments, the main control board is clamped on the holder. In some embodiments, the atomization assembly includes a conductive connection portion;
a support wall for supporting the atomization assembly is arranged on the holder; a wire hole for the conductive connection portion to run through is provided on the support wall;
the cross-sectional size of the wire hole is greater than the cross-sectional size of the conductive connection portion; and
the electronic atomization device further includes a seal structure, and the seal structure is arranged on one side of the wire hole away from the atomization assembly, and for sealing the wire hole.

In some embodiments, the seal structure includes a first seal surface arranged opposite to the wire hole; and
a first seal convex rib is provided on the first seal surface.

In some embodiments, an accommodating cavity for accommodating a part of the seal structure is arranged on the holder, and
the seal structure includes a second seal surface; the second seal surface is arranged opposite to the bottom wall of the accommodating cavity, and a part of the conductive connection portion running out of the wire hole is pressed on the second seal surface; and
a second seal convex rib is provided on the second seal surface.

In some embodiments, the electronic atomization device further includes a controller connected to the main control board and a mounting base for mounting the controller; and the seal structure is formed on the mounting base.

In some embodiments, the electronic atomization device further includes a start airway, and the start airway is arranged apart from the liquid storage cavity, and partially formed on the mounting base.

In some embodiments, the electronic atomization device further includes a first cavity for accommodating the battery cell; and
the electronic atomization device includes a holder, and the liquid storage cavity and/or the first cavity are formed on the holder.

In some embodiments, the holder is a transparent structure.

Implementing the electronic atomization device in the present invention has the following beneficial effects: In the electronic atomization device, the charging interface is directly arranged on the main control board, so that the use of flexible wires can be reduced and the welding joints can be reduced, which is conducive to automatic assembly, thereby reducing times of welding, improving assembly efficiency, and improving quality of products, and further reducing manufacturing costs and improving the service life of the products and user experience.

List of reference numerals: 100: electronic atomization device; 10: shell; 11: accommodating space; 12: assembly port; 13: air inlet hole; 14: jack; 20: holder; 21: first side wall; 211: through hole; 212: air inlet groove; 213: buckle; 22: second side wall; 221: retaining wall; 222: notch; 23: support wall; 231: wire hole; 232: accommodating cavity; 2321: bottom wall; 24: receiving cavity; 241: first cavity; 242: second cavity; 25: third side wall; 26: liquid storage cavity; 27: air guide column; 30: atomization assembly; 31: vent tube; 311: first tube section; 3110: atomization cavity; 3111: liquid inlet hole; 321: conductive connection portion; 312: second tube section; 40: power supply assembly; 41: battery cell; 41a: first end; 41b: second end; 411: electrode; 42: main control board; 421: first connection point; 422: second connection point; 423: mouth; 43: charging interface; 50: controller; 60: mounting base; 61: base body; 610: accommodating slot; 62: seal structure; 621: first seal surface; 6211: first seal convex rib; 622: second seal surface; 6221: second seal convex rib; 63: air guide structure; 70: suction nozzle assembly; 80: air inlet channel; and 90: start airway.

To have a clearer understanding of the technical features, the objectives, and the effects of the present invention, specific implementations of the present invention are now illustrated in detail with reference to the accompanying drawings. In the following description, it should be understood that orientation or position relationships indicated by terms such as “upper”, “lower”, “longitudinal”, “transverse”, “top”, “bottom”, “inner”, and “outer” are based on orientation or position relationships shown in the accompanying drawings and structures and operations in specific orientations, and are used only for case of description of the technical solutions, rather than indicating that the mentioned device or element needs to have a particular orientation. Therefore, such terms should not be construed as a limitation to the present invention.

It should be further noted that, unless otherwise explicitly specified and defined, terms such as “mounted”, “connected”, “connection”, “fixed”, and “arranged” should be understood in a broad sense. For example, the connection may be a fixed connection, a detachable connection, or an integral connection; or the connection may be a mechanical connection or an electrical connection; or the connection may be a direct connection, an indirect connection through an intermediate, or internal communication between two elements or an interaction relationship between two elements. When an element is referred to as being “on” or “under” another element, it can be “directly” or “indirectly” located on the another element, or one or more elements may exist therebetween. Terms such as “first”, “second”, and “third” are merely intended for case of description of the technical solutions, and shall not be understood as indicating or implying relative importance or implicitly indicating the number of indicated technical features. Therefore, features defined as “first”, “second”, “third”, and the like may explicitly or implicitly include one or more of the features. A person of ordinary skill in the art may understand the specific meanings of the foregoing terms in the present invention according to specific situations.

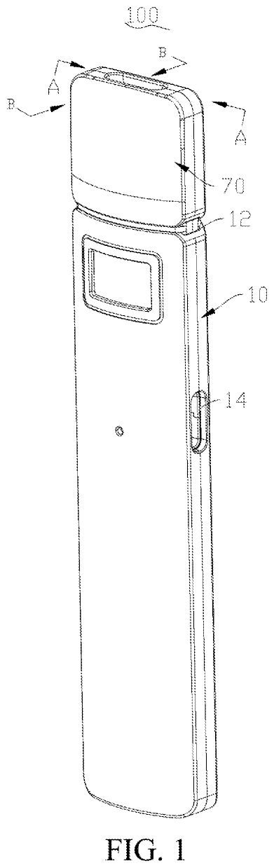

FIG. 1 shows some preferred embodiments of an electronic atomization device in the present invention. The electronic atomization device 100 may be configured to atomize a liquid substrate to generate an aerosol, and the aerosol may be for a user to inhale. The electronic atomization device 100 may be in a shape of a flat column in some embodiments. The electronic atomization device 100 may be a disposable electronic atomization device. Certainly, it may be understood that in some other embodiments, the electronic atomization device 100 is not limited to a disposable electronic atomization device. The liquid substrate may include an e-liquid, a liquid medicine, or the like. The electronic atomization device 100 has the advantages of high assembly efficiency, low manufacturing costs, good quality, and high user experience.

As shown in FIG. 1 to FIG. 3, in some embodiments, the electronic atomization device 100 includes a shell 10, a holder 20, an atomization assembly 30, and a power supply assembly 40. The shell 10 is for accommodating the holder 20, the atomization assembly 30, and the power supply assembly 40. The holder 20 is arranged in the shell 10, and configured to support the atomization assembly 30 and the power supply assembly 40. The atomization assembly 30 is configured to atomize the liquid substrate to generate the aerosol. The power supply assembly 40 may be electrically connected to the atomization assembly 30, to supply power to the atomization assembly 30.

The shell 10 may be in a shape of a flat elongated sleeve, with a hollow inside and an accommodating space 11 formed therein. An assembly port 12 is provided on one end of the shell 10, for the holder 20 to be assembled. An air inlet hole 13 is provided on the other end of the shell 10, for external air to enter. In some embodiments, a jack 14 may be provided on the side wall of the shell 10, and the jack 14 is for an external power cord to plug in. It may be understood that in some other embodiments, the shell 10 is not limited to a shape of a flat elongated sleeve.

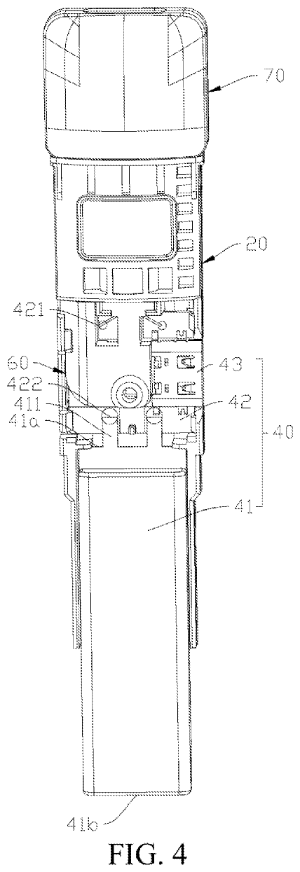

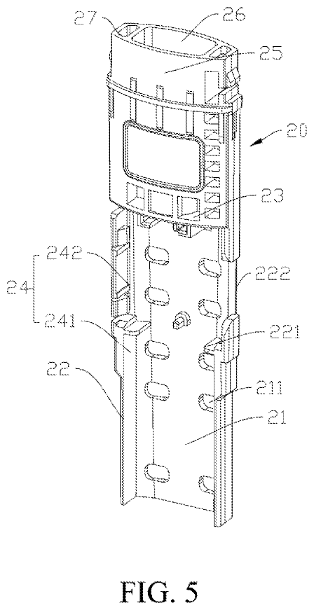

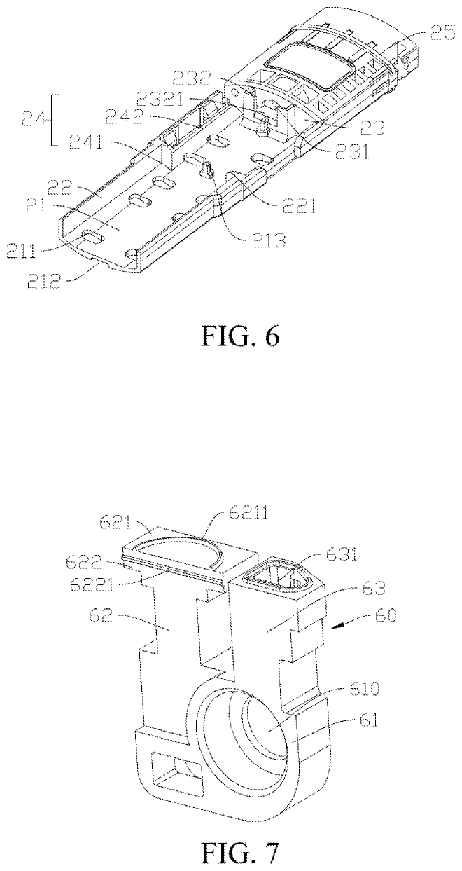

As shown in FIG. 4 to FIG. 6, in some embodiments, the holder 20 may be a transparent structure. Specifically, the holder 20 may be made of transparent plastics, which is conducive to making the electronic atomization device 100 better looking. It may be understood that in some other embodiments, the holder 20 is not limited to a transparent structure, or may be a semi-transparent structure or an opaque structure. The holder 20 includes a first side wall 21, a second side wall 22, a support wall 23, and a third side wall 25. In some embodiments, the first side wall 21 may be arranged lengthwise. Two second side walls 22 are provided, and each second side wall 22 is arranged lengthwise. The two second side walls 22 are arranged on two opposite sides of the first side wall 21, and have the length direction parallel to the length direction of the first side wall 21. The two second side walls 22 and the first side wall 21 enclose to form a lengthwise receiving cavity 24. The receiving cavity 24 is for accommodating the power supply assembly 40. The support wall 23 is arranged at one end of the receiving cavity 24, to support the first side wall 30. The third side wall 25 is arranged on the support wall 23, and encloses with the support wall 23 and the first side wall 21 to form a liquid storage cavity 26, to store the liquid substrate. That is, the liquid storage cavity 26 is formed on the holder 20, and is integrally designed with the holder 20, reducing the assembly costs. In some embodiments, an air guide column 27 is arranged on the holder 20. The air guide column 27 is arranged apart from the liquid storage cavity 26. The air guide column 27 is a structure with two run-through ends, and a part of a start airway 90 may be formed on the inner side of the air guide column 27.

A through hole 211 is provided on the first side wall 21, and the through hole 211 may be a heat dissipation hole, for the power supply assembly 40 to dissipate heat. In some embodiments, an air inlet groove 212 is provided on one side of the first side wall 21 facing away from the receiving cavity 24. The air inlet groove 212 may extend from one end of the first side wall 21 away from the support wall 23 to the support wall 23, and the air inlet groove 212 may be in communication with an air inlet hole 13, for external air to enter the first side wall 30. It may be understood that, in some embodiments, the through hole 211 may be omitted. The air inlet groove 212 is not limited to being provided on the first side wall 21, for example, may be provided on the second side wall 22 or the inner side wall of the shell 10.

In some embodiments, a retaining wall 221 is arranged on the inner side of each second side wall 22. The length of the retaining wall 221 is less than the width of the first side wall 21, and a set distance is reserved between the retaining wall 221 and the support wall 23. Specifically, the distance between the retaining wall 221 and the support wall 23 is less than the distance between the retaining wall 221 and one end of the first side wall 21 away from the liquid storage cavity 26. The two retaining walls 221 on the two second side walls 22 divide the receiving cavity 24 into a first cavity 241 and a second cavity 242. The first cavity 241 and the second cavity 242 are arranged in the length direction of the first side wall 21 side by side, and are in communication with each other. The second cavity 242 may be arranged close to the support wall 23. A notch 222 is provided on the second side wall 22. The notch 222 and the jack 14 are provided opposite to each other, and are in communication with each other. The notch 222 is for avoiding a charging interface 43 in the power supply assembly 40.

In some embodiments, a wire hole 231 is provided on the support wall 23; and the wire hole 231 is provided on the center of the support wall 23. The cross-sectional size of the wire hole 231 is greater than the cross-sectional size of the conductive connection portion 321 of the atomization assembly 30. Specifically, in some embodiments, the wire hole 231 is in a semi-circular shape, and has the diameter greater than 0.7 mm. Further, in some embodiments, the diameter of the wire hole 231 may be greater than 1.4 mm. In some embodiments, the wire hole 231 may not be limited to a semi-circular shape, and in some other embodiments, the wire hole 231 may be in a semi-elliptical shape, a rectangular shape, or the like. The cross-sectional size of the wire hole 231 is increased, so that the conductive connection portion 321 of the atomization assembly 30 can easily run through, thereby improving the assembly efficiency. Specifically, the two conductive connection portions 321 of the atomization assembly 30 can easily run through together. In some embodiments, an accommodating cavity 232 is provided on the holder 20. Specifically, the accommodating cavity 232 is provided on one side of the support wall 23 facing away from the liquid storage cavity 26. The accommodating cavity 232 and the wire hole 231 are coaxially provided, and are in communication with each other, to accommodate a seal structure 62 for sealing the wire hole 231.

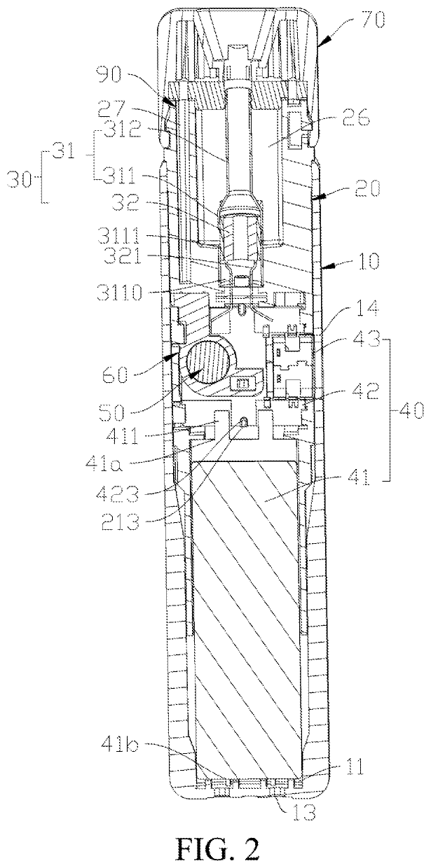

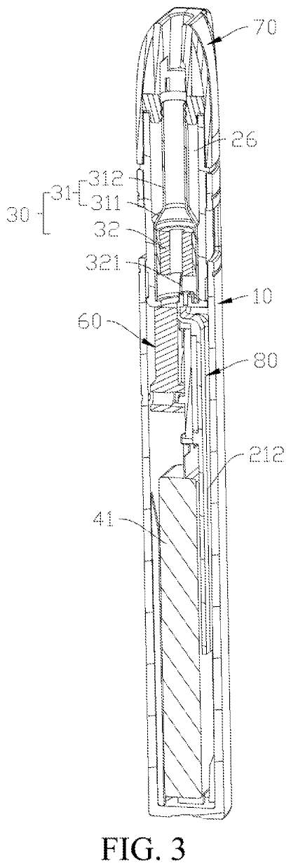

As shown in FIG. 2 and FIG. 3, in some embodiments, the atomization assembly 30 includes a vent tube 31 and a heating structure 32. The vent tube 31 is inserted on the support wall 23, and is arranged in the center of the liquid storage cavity 26, and one end of the vent tube 31 is connected to a suction nozzle assembly 70. In some embodiments, the vent tube 31 includes a first tube section 311 and a second tube section 312. The first tube section 311 and the second tube section 312 are coaxially arranged, and the first tube section 311 is arranged at one end of the second tube section 312, and has the cross-sectional size greater than the cross-sectional size of the second tube section 312. In some embodiments, the heating structure 32 is mounted in the first tube section 311, so that the inner side of the first tube section 311 forms an atomization cavity 3110. The second tube section 312 is in communication with the first tube section 311, and the inner side of the second tube section 312 forms an air outlet channel. In some embodiments, a liquid inlet hole 3111 is provided on the tube wall of the vent tube 31 arranged corresponding to the heating structure 32. Specifically, two liquid inlet holes 3111 are provided, and the two liquid inlet holes 3111 are provided on the tube wall of the first tube section 311, and located on two opposite sides of the first tube section 311. Certainly, it may be understood that in some other embodiments, the number of the liquid inlet holes 3111 is not limited to two, and may be one or more than two. In some embodiments, the heating structure 32 may be in a cylindrical shape, and is a hollow structure with two run-through ends.

A central through hole of the heating structure 32 is coaxially provided with the first tube section 311 and the second tube section 312, and is in communication with the first tube section 311 and the second tube section 312 respectively. The heating structure 32 may absorb the liquid substrate in the liquid storage cavity 26 through the liquid inlet hole 3111, and the liquid substrate is atomized to generate the aerosol in a power-up state. It may be understood that in some other embodiments, the heating structure 32 is not limited to a cylindrical shape.

In some embodiments, the atomization assembly 30 further includes the conductive connection portion 321. Two conductive connection portions 321 are provided, and the two conductive connection portions 321 may be led out from the heating structure 32, and may be led out to the second cavity 242 sequentially through an opening of one end of the first tube section 311 and the wire hole 231. The atomization assembly 30 is conductively connected to the power supply assembly 40 by the two conductive connection portions 321. In some embodiments, the conductive connection portion 321 may be a lead. Certainly, it may be understood that in some other embodiments, the conductive connection portion 321 is not limited to a lead, and may be an ejector pin or a conductive sheet.

In some embodiments, the power supply assembly 40 is accommodated in the receiving cavity 24. Specifically, the power supply assembly 40 includes a battery cell 41, a main control board 42, and the charging interface 43. The battery cell 41 is accommodated in the first cavity 241, and is configured to supply power to the atomization assembly 30. The main control board 42 is arranged on the holder 20, and is located between the battery cell 41 and the liquid storage cavity 26. Specifically, the main control board 42 is arranged in the second cavity 242, and is conductively connected to the atomization assembly 30. Further, the main control board 42 is connected to the conductive connection portion 321 of the atomization assembly 30. The charging interface 43 is arranged on the main control board 42. In other words, the charging interface 43 may be located in the second cavity 242, and is located at the notch 222 and arranged opposite to the jack 14. A power cord of an external power supply may be plugged in the charging interface 43 through the jack 14, to charge the battery cell 41. In some embodiments, the charging interface 43 may be welded onto the main control board 42, thereby reducing use of flexible wires, reducing welding points, reducing costs, and facilitating automatic assembly. In some other embodiments, the charging interface 43 is not limited to being welded onto the main control board 42, and may alternatively be fixed on the main control board 42 by plugging or patching.

The battery cell 41 may be approximately in a cuboid shape. Certainly, it may be understood that in some other embodiments, the battery cell 41 may not be limited to a cuboid shape. The battery cell 41 may be a square soft pack battery cell. In some embodiments, the battery cell 41 may include a first end 41a and a second end 41b. The first end 41a is arranged facing toward the atomization assembly 30. Specifically, in some embodiments, the first end 41a may be arranged facing toward the support wall 23. The second end 41b may be arranged opposite to the first end 41a. An electrode 411 is arranged on the battery cell 41. The electrode 411 is located at the first end 41a, and may extend from the first cavity 241 to the second cavity 242, to be connected to the main control board 42, so that the battery cell 41 is connected to the main control board 42. In some embodiments, the electrode 411 may be welded to the main control board 42. It may be understood that in some other embodiments, the electrode 411 is not limited to being welded to the main control board 42, and may alternatively be in clastic contact with the main control board 42, to implement conductive connection.

In some embodiments, the main control board 42 is a PCBA board, and is specifically mounted between the first end 41a and the liquid storage cavity 26. It may be understood that in some other embodiments, the main control board 42 may alternatively be mounted on the outer side of the liquid storage cavity 26, and is arranged facing away from the atomization assembly 30, that is, mounted on one side of the holder 20 facing away from the atomization assembly 30. It may be understood that in some other embodiments, the main control board 42 may be arranged on one side of the battery cell 41, and located at the first end 41a and the second end 41b, and specifically, may be arranged close to the first end 41a. The main control board 42 is arranged at the first end 41a, the charging interface 43 is mounted on the main control board 42, and the atomization assembly 30 and the battery cell 41 are both connected to the main control board 42, so that the welding joints can be reduced, and the use of flexible wires can be reduced, which is conducive to automatic assembly, thereby reducing manufacturing costs, and improving production efficiency.

In some embodiments, a first connection point 421 is provided on the main control board 42. The conductive connection portion 321 may be connected to the first connection point 421. In some embodiments, the first connection point 421 may be a welding joint, that is, the conductive connection portion 321 may be connected to the main control board 42 at the first connection point 421 through welding. It may be understood that in some other embodiments, the first connection point 421 is not limited to a welding joint, and may be a contact. The conductive connection portion 321 may be pressed on the contact, and in contact with the contact to implement electrical connection. Two first connection points 421 may be provided, and are arranged in a one-to-one correspondence to the two conductive connection portions 321.

In some embodiments, a second connection point 422 connected to the battery cell 41 is provided on the main control board 42. The electrode 411 of the battery cell 41 may extend to the second connection point 422, to be conductively connected to the second connection point 422, so that the battery cell 41 is connected to the main control board 42. In some embodiments, the second connection point 422 may be a welding joint, and the electrode 411 of the battery cell 41 may be connected to the main control board 42 at the second connection point 422 through welding. Two second connection points 422 may be provided, and are in a one-to-one correspondence to the two electrodes 411. In some other embodiments, the second connection point 422 is not limited to a welding joint, and may be a contact. The electrode 411 may be in contact with the second connection point 422 to be turned on.

In some embodiments, the main control board 42 may be clamped on the holder 20. Specifically, a mouth 423 is provided on the main control board 42, a buckle 213 is provided on the first side wall 21, and the buckle 213 is provided corresponding to the mouth 423. When the main control board 42 is assembled to the holder 20, the buckle 213 may be clamped into the mouth 423. In some embodiments, the main control board 42 is not limited to being fixed on the holder 20 by clamping. In some other embodiments, the main control board 42 may alternatively be connected to the holder 20 by arranging a thread assembly.

In some embodiments, the charging interface 43 may be a USB interface. It may be understood that in some other embodiments, the charging interface 43 is not limited to a USB interface, and may be a Type-C interface or the like. The charging interface 43 is directly mounted on the main control board 42, and does not require an additional circuit board or flexible wires, so that the manufacturing costs can be reduced.

In some embodiments, the electronic atomization device 100 further includes a controller 50. The controller 50 may be connected to the main control board 42, and configured to turn on or turn off the atomization assembly 30. In some embodiments, the controller 50 may be a start-up switch, for example, a microphone. It may be understood that in some other embodiments, the controller 50 is not limited to a microphone.

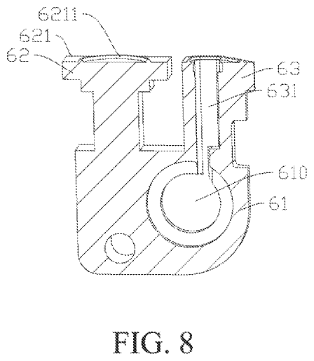

As shown in FIG. 4, FIG. 7, and FIG. 8, in some embodiments, the electronic atomization device 100 further includes a mounting base 60. The mounting base 60 is arranged on the holder 20, and is specifically mounted in the second cavity 242, for mounting the controller 50. The mounting base 60 includes a base body 61. An accommodating slot 610 is provided on the base body 61, and the accommodating slot 610 is for accommodating the controller 50.

In some embodiments, the mounting base 60 further forms the seal structure 62. The seal structure 62 is protruded from the base body 61, and may extend toward the direction of the support wall 23. The seal structure 62 is an elastic structure. The longitudinal section of the seal structure 62 may be approximately in a T shape. Certainly, it may be understood that in some other embodiments, the seal structure 62 is not limited to a T shape, and may be in a cuboid shape, a semi-cylindrical shape, or other shapes. In some embodiments, a part of the seal structure 62 with a larger cross-sectional size may be arranged in the accommodating cavity 232, and the cross-sectional shape and size of the part may be the same as the cross-sectional shape and size of the accommodating cavity 232. The seal structure 62 may be arranged on one side of the wire hole 231 away from the atomization assembly 30, and may seal the wire hole 231, to prevent the liquid substrate from leaking from the wire hole 231 into the second cavity 242 to pollute the power supply assembly 40. In addition, the reduction of suction resistance caused by air leakage can be avoided. The seal structure 62 is integrally formed on the base body 61, so that materials can be reduced, and the assembly procedure can be simplified, making the structure more reliable.

In some embodiments, the seal structure 62 includes a first seal surface 621. The first seal surface 621 is an end surface arranged opposite to the wire hole 231. The first seal surface 621 may be attached to the support wall 23 for sealing. The first seal surface 621 may be in a rectangular shape, and has the length greater than the diameter of the wire hole 231 and the width greater than the radius of the wire hole 231. It may be understood that in some other embodiments, the first seal surface 621 is not limited to a rectangular shape, and may be in a semi-circular shape, provided that the radius of the first seal surface 621 is greater than the diameter of the wire hole 231. In some embodiments, a first seal convex rib 6211 is provided on the first seal surface 621, and the shape of the first seal convex rib 6211 may be adapted to the shape of the wire hole 231. In some embodiments, the first seal convex rib 6211 may be approximately in the shape of a semi-circular ring, and has the radial size slightly greater than the radial size of the wire hole 231. When the first seal surface 621 is in contact with the support wall 23, the first seal convex rib 6211 may abut against the periphery of the wire hole 231 to prevent the liquid substrate form leaking, and the reduction of suction resistance caused by air leakage can be avoided.

In some embodiments, the seal structure 62 includes a second seal surface 622. The second seal surface 622 may be arranged perpendicular to the first seal surface 621. The second seal surface 622 may be in a T shape. In some embodiments, the second seal surface 622 is arranged opposite to the bottom wall 2321 of the accommodating cavity 232, and may be attached to the bottom wall 2321 for sealing. A part of the conductive connection portion 321 running out of the wire hole 231 may be pressed on the second seal surface 622. In some embodiments, a second seal convex rib 6221 is provided on the second seal surface 622. The second seal convex rib 6221 may be arranged lengthwise, and has the length direction parallel to the length direction of the second seal surface 622. In some embodiments, the second seal convex rib 6221 is not limited to an elongated rib, and may be a dot or in other shapes. When the seal structure 62 is partially clamped in the accommodating cavity 232, the second seal convex rib 6221 may abut against the bottom wall 2321, to further prevent the liquid substrate from leaking, and the reduction of suction resistance caused by air leakage can be avoided.

In some embodiments, the mounting base 60 further includes an air guide structure 63. The air guide structure 63 is arranged on the base body 61, and is integrally formed with the base body 61. In some embodiments, the air guide structure 63 may be in contact with one end of the air guide column 27, and in communication with the air guide column 27. An air guide channel 631 in communication with the accommodating slot 610 is arranged on the inner side of the air guide structure 63. The air guide channel 631 is in communication with a channel in the air guide column 27 to form the start airway 90. When the user inhales, the controller 50 may sense, through the start airway 90, the negative pressure generated by the inhalation.

In some embodiments, the electronic atomization device 100 further includes the suction nozzle assembly 70. The suction nozzle assembly 70 is sleeved on the holder 20, and is specifically mounted at one end of the holder 20 at which the liquid storage cavity 26 is provided, and in communication with the vent tube 31, for the user to inhale the aerosol generated by the atomization assembly 30 atomizing the liquid substrate.

Referring to FIG. 2 and FIG. 3 again, in some embodiments, the electronic atomization device 100 further includes an air inlet channel 80. The air inlet channel 80 is arranged on one side of the holder 20 facing away from the main control board 42, and is air guide connection to the atomization assembly 30, for the external air to enter the atomization assembly 30 and bring the aerosol out. Specifically, in some embodiments, the air inlet channel 80 is at least partially formed between the holder 20 and the shell 10, and is in communication with the air inlet hole 13. Further, the air inlet channel 80 may be formed between the air inlet groove 212 and the inner wall of the shell 10. One end of the air inlet channel 80 is in communication with the air inlet hole 13, and the other end is in communication with the atomization cavity 3110. The air inlet channel 80 is arranged on the side of the holder 20 facing away from the main control board 42, so that the external air can enter the atomization cavity 3110 without passing the main control board 42, thereby preventing the liquid substrate from affecting the main control board 42 when the liquid substrate leaks from the air inlet channel 80.

In some embodiments, the electronic atomization device 100 further includes the start airway 90. The start airway 90 is partially formed on the holder 20, and partially formed on the mounting base 60. Specifically, the start airway 90 may be formed in the air guide column 27 and the air guide channel 631 of the air guide structure 63. One end of the start airway 90 is in communication with the suction nozzle assembly 70, and the other end is in communication with the accommodating slot 610. The controller 50 may sense, through the start airway 90, the negative pressure generated by user inhalation at the suction nozzle assembly 70. The start airway 90 is arranged completely apart from the liquid storage cavity 26, that is, arranged independent of the liquid storage cavity 26, thereby preventing the liquid substrate in the liquid storage cavity 26 from leaking from the start airway 90 to the controller 50, to prevent damage of the controller 50.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An electronic atomization device, comprising:
a liquid storage cavity configured to store a liquid substrate;
an atomization assembly arranged in the liquid storage cavity, the atomization assembly being configured to atomize the liquid substrate; and
a power supply assembly comprising a main control board connected to the atomization assembly, a battery cell connected to the main control board, and a charging interface arranged on the main control board.

2. The electronic atomization device of claim 1, wherein the battery cell comprises a first end facing toward the liquid storage cavity and a second end arranged opposite the first end, and
wherein the main control board is arranged between the first end and the liquid storage cavity.

3. The electronic atomization device of claim 1, wherein the atomization assembly comprises a conductive connection portion, and
wherein a first connection point connected to the conductive connection portion is provided on the main control board.

4. The electronic atomization device of claim 3, wherein a second connection point connected to the battery cell is provided on the main control board.

5. The electronic atomization device of claim 1, further comprising:
a holder,
wherein the main control board is arranged on the holder.

6. The electronic atomization device of claim 5, further comprising:
an air inlet channel in air guide connection to the atomization assembly,
wherein the air inlet channel is arranged on one side of the holder facing away from the main control board.

7. The electronic atomization device of claim 6, wherein the atomization assembly comprises a vent tube and a heating structure arranged in the vent tube,
wherein the air inlet channel is in communication with the vent tube, and
wherein a liquid inlet hole in liquid guide connection to the liquid storage cavity is provided on a tube wall of the vent tube arranged corresponding to the heating structure.

8. The electronic atomization device of claim 7, further comprising:
a shell configured to accommodate the holder,
wherein the air inlet channel is at least partially formed between the shell and the holder.

9. The electronic atomization device of claim 5, wherein the main control board is clamped on the holder.

10. The electronic atomization device of claim 5, wherein the atomization assembly comprises a conductive connection portion,
wherein a support wall for supporting the atomization assembly is arranged on the holder,
wherein a wire hole for the conductive connection portion to run through is provided on the support wall,
wherein a cross-sectional size of the wire hole is greater than a cross-sectional size of the conductive connection portion, and
wherein the electronic atomization device further comprises a seal structure arranged on one side of the wire hole away from the atomization assembly, the seal structure being configured to seal the wire hole.

11. The electronic atomization device of claim 10, wherein the seal structure comprises a first seal surface arranged opposite the wire hole, and
wherein a first seal convex rib is provided on the first seal surface.

12. The electronic atomization device of claim 10, wherein an accommodating configured to accommodate a part of the seal structure is arranged on the holder,
wherein the seal structure comprises a second seal surface arranged opposite a bottom wall of the accommodating cavity,
wherein a part of the conductive connection portion running out of the wire hole is pressed on the second seal surface, and
wherein a second seal convex rib is provided on the second seal surface.

13. The electronic atomization device of claim 10, further comprising:
a controller connected to the main control board; and
a mounting base configured to mount the controller,
wherein the seal structure is formed on the mounting base.

14. The electronic atomization device of claim 13, further comprising:
a start airway arranged apart from the liquid storage cavity, the start airway being partially formed on the mounting base.

15. The electronic atomization device of claim 1, further comprising:
a first cavity configured to accommodate the battery cell; and
a holder,
wherein the liquid storage cavity and/or the first cavity are formed on the holder.

16. The electronic atomization device of claim 15, wherein the holder comprises a transparent structure.
